(19) United States
(12) Patent Application Publication
(10) Pub. No.: US 2013/0156218 A1
(43) Pub. Date: Jun. 20, 2013

(54) Enclosure System With Acoustic Element

(71) Applicants: William R. Annacone, Stowe, VT (US); Robert G. Johnston, Amprior (CA); Martyn D. Miller, Amprior (CA)

(72) Inventors: William R. Annacone, Stowe, VT (US); Robert G. Johnston, Amprior (CA); Martyn D. Miller, Amprior (CA)

(21) Appl. No.: 13/664,469

(22) Filed: Oct. 31, 2012

Related U.S. Application Data
(60) Provisional application No. 61/576,978, filed on Dec. 16, 2011.

(51) Int. Cl. H04R 1/02; B32B 38/00; B29C 45/00

(52) U.S. Cl. 381/87; 156/245

(57) ABSTRACT

Watertight enclosures for digital audio devices include one or more diaphragms for transmitting sound to and/or from the digital device's audio transducers, such as speakers and microphones. To mitigate standing waves and/or prominent natural frequencies, a central portion of the diaphragm is wavy with a relatively low Q (Young's modulus). The central portion is encircled by a peripheral web portion that is relatively thin to provide the central portion with spring support. In some examples, the diaphragm also includes a seal for sealing against the digital device's housing to create a generally closed air chamber between the diaphragm and the audio transducer. The closed air chamber promotes sound transfer between the diaphragm and the audio transducer. The closed air chamber can also reduce crosstalk between a microphone and a proximate speaker. In some examples, a relatively soft diaphragm and a harder enclosure are created using plastic injection overmolding.

### CROSS REFERENCE TO RELATED APPLICATIONS

This application claims the benefit of provisional patent application Ser. No. 61/576,978 filed on Dec. 16, 2011 by the present inventors.

### FIELD OF THE INVENTION

The subject invention generally pertains to watertight enclosures for digital audio devices and more specifically to means for transmitting sound waves through such enclosures.

### BACKGROUND

Some examples of digital audio devices and digital audio players include a telephone, digital music player, camera, computer, tablet computer, computer monitor, personal digital assistant, video game player, PLC (programmable logic controller), GPS unit (global positioning system), IPHONE, IPOD, IPAD, etc. The terms, iPhone, iPod and iPad are registered trademarks of Apple, Inc. of Cupertino, Calif. Sometimes digital devices are installed in an enclosure in which the digital device can be inserted and removed. Some enclosures can be ineffective in clearly transmitting sound to and/or from the digital device's audio transducers, such as speakers and microphones.

### BRIEF DESCRIPTION OF THE DRAWINGS

FIG. 1 a front view of an example enclosure in a closed configuration but not currently containing a digital device.

FIG. 2 is a bottom view of FIG. 1.

FIG. 3 is a front view of the enclosure shown FIG. 1 but showing an example digital device installed in the enclosure.

FIG. 4 is a bottom view of FIG. 3.

FIG. 5 is a front view showing the enclosure in an open configuration with the digital device being installed.

FIG. 6 is a cross-sectional view taken along line 6-6 of FIG. 3.

FIG. 7 is a cross-sectional view taken along line 7-7 of FIG. 1.

FIG. 8 is a cross-sectional view taken along line 8-8 of FIG. 1.

FIG. 9 is a cross-sectional view taken along line 9-9 of FIG. 3.

FIG. 10 is front view of an example diaphragm.

FIG. 11 is a cross-sectional view taken along line 11-11 of FIG. 2.

FIG. 12 is a cross-sectional view taken along line 12-12 of FIG. 4.

FIG. 13 is a schematic view of an overmolding plastic injection apparatus and method for making an example enclosure with an attached diaphragm.

FIG. 14 is a block diagram illustrating an example enclosure method.

### DETAILED DESCRIPTION

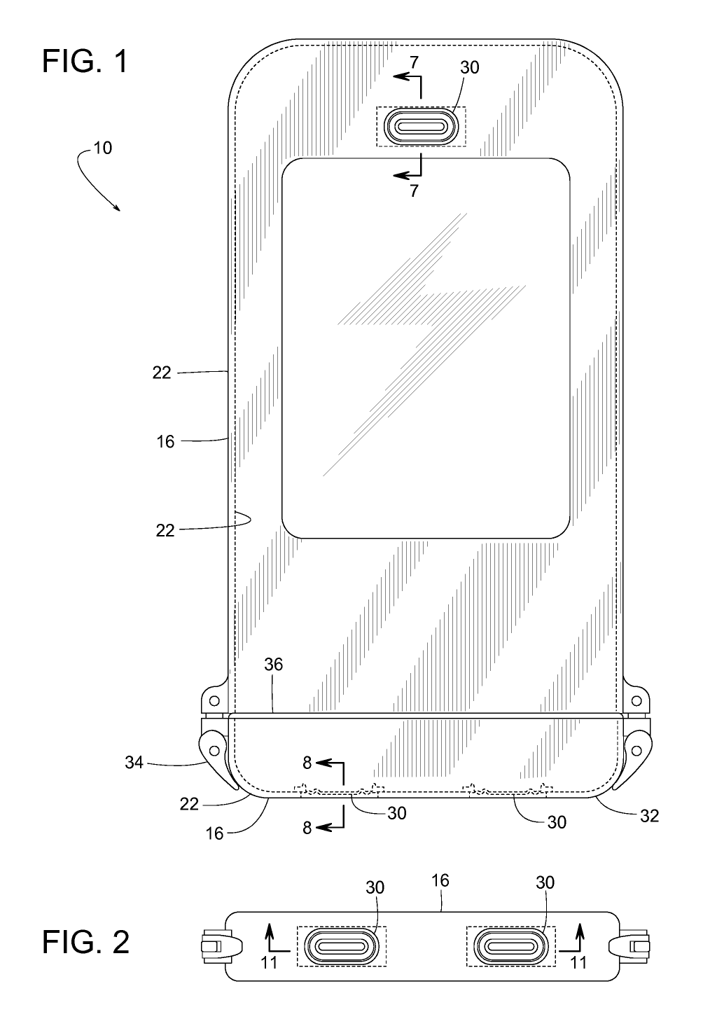

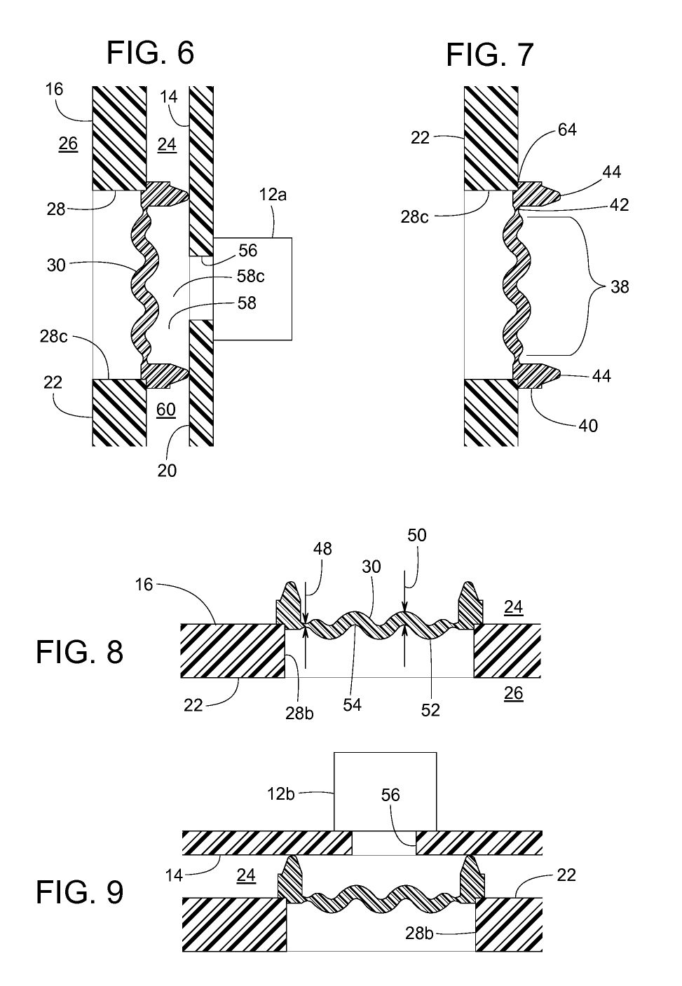

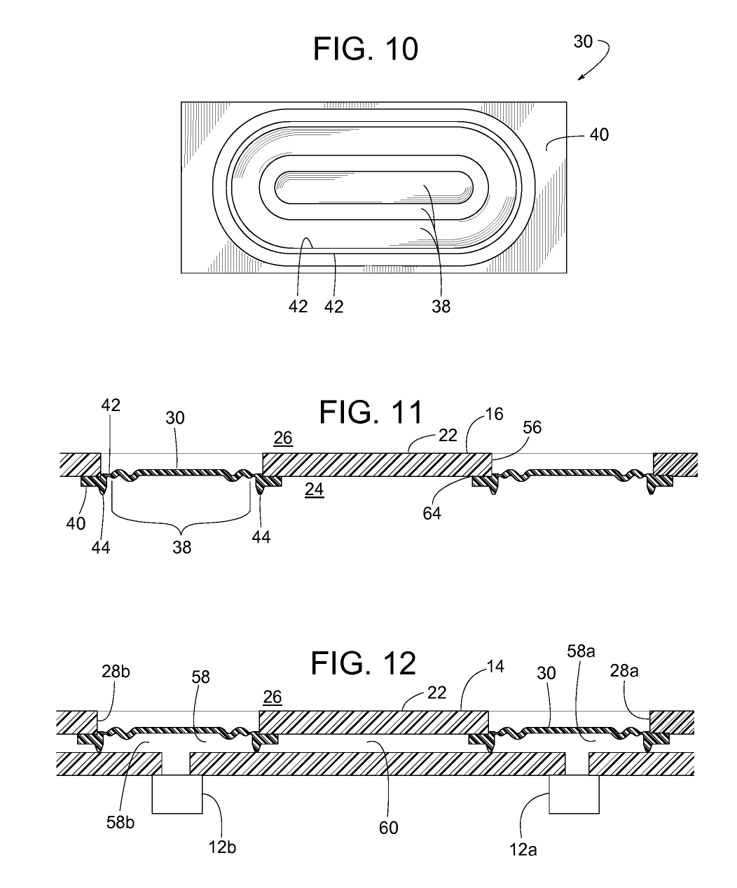

FIGS. 1-14 illustrate an example enclosure system 10, method and/or various portions thereof System 10 is particularly useful in transmitting sound to or from an audio transducer 12 of a digital device 14 (e.g., digital audio device, digital audio player, etc.) held inside a water-tight enclosure 16. Examples of digital device 14 include, but are not limited to, a telephone, digital music player, camera, computer, tablet computer, computer monitor, personal digital assistant, video game player, PLC (programmable logic controller), GPS unit (global positioning system), IPHONE, IPOD, IPAD, etcetera. The terms, iPhone, iPod and iPad are registered trademarks of Apple, Inc. of Cupertino, CA. Examples of digital device 14 include both portable and generally immobile devices. Some examples of a “telephone” include, but are not limited to, a cell phone, smartphone, satellite phone, etc. Examples of audio transducer 12 include, but are not limited to, a speaker 12a and a microphone 12b.

For sake of example, digital device 14 is illustrated and described as being a telephone that includes one microphone 12b and two speakers 12a. Microphone 12b at a lower edge 18 of digital device 14 can be used for inputting voice or other sounds to device 14. One speaker 12a on a face 20 of digital device 14 can be used by a person for listening to a phone conversation while device 14 is held near the person's ear. Another, perhaps more powerful speaker 12a, at lower edge 18 emits sound that can be readily heard without the person having to hold device 14 up against their ear.

To transmit sound to and from audio transducers 12, some examples of enclosure 16 comprise an enclosure wall 22 defining an interior space 24, an exterior 26 (i.e., the outer space surrounding enclosure 14), an acoustic window area 28 (e.g. acoustic window areas 28a, 28b and/or 28c), and a diaphragm 30 disposed at each window area 28. Window area 28 are openings of any shape in enclosure wall 22, and diaphragm 30 cover and hermetically seal those openings.

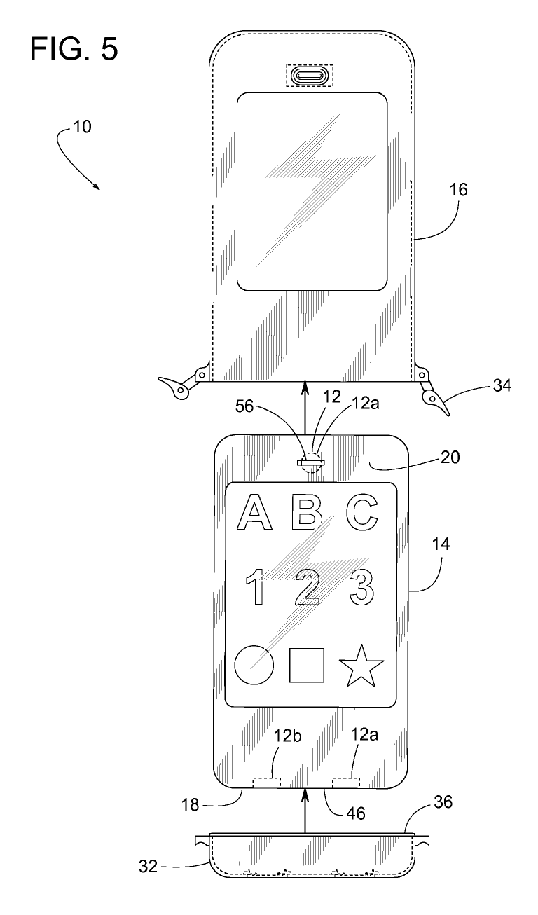

Acoustic windows 28 are located so as to align each diaphragm 30 with a corresponding audio transducer 12 when digital device 14 is installed within interior space 24 and enclosure 16 is closed. In the illustrated example, enclosure 16 includes a hatch 32 that selectively configures enclosure 16 in its closed configuration (FIGS. 1-4) and its open configuration (FIG. 5). In some examples, cam latches 34 and a seal 36 hold enclosure 16 tightly closed to hermetically isolate interior space 24 from exterior 26.

Diaphragm 30 is sufficiently flexible to vibrate to transmit sound waves through acoustic window areas 28. In some examples, each diaphragm 30 comprises a central portion 38, a mounting flange 40 for joining diaphragm 30 to enclosure wall 22 or to hatch 32, a web portion 42 encircling central portion 38 and extending between flange 40 and central portion 38, and a seal 44 extending from mounting flange 40 to seal against an outer surface 46 of digital device 14. Web portion 42 encircling central portion 38 means that web portion 42 surrounds central portion 38 and does not necessarily mean that web portion 42 is circular.

Web portion 42 is relatively thin in that it has a material thickness 48 that is appreciably less than a material thickness 50 of central portion 38. In some examples, thickness 50 is more than twice as great as thickness 48. In some examples, thickness 48 is about 0.13 mm and thickness 50 is about 0.51 mm. The relative material thicknesses of web portion 42 and central portion 38 enables web portion 42 to serve as a spring supporting the much thicker central portion 38.

Web portion 42 functioning as a spring allows central portion 38 to vibrate freely but with central portion 38 vibrating in and out mostly as a unit, as opposed to central portion 38 carrying significant adverse standing waves or vibrating at some overly prominent natural frequency. Such standing waves and/or natural frequency is further mitigated by having central portion 38 be wavy or at least less planar than web portion 42. The term, “wavy” means central portion includes peaks 52 and valleys 54. In some examples, standing waves and/or the central portion's natural frequency is even further minimized by having central portion 38 be made of a material that is relatively soft and flexible with a relatively low Young's modulus. In some examples, central portion 38 is softer than the material of enclosure wall 22.

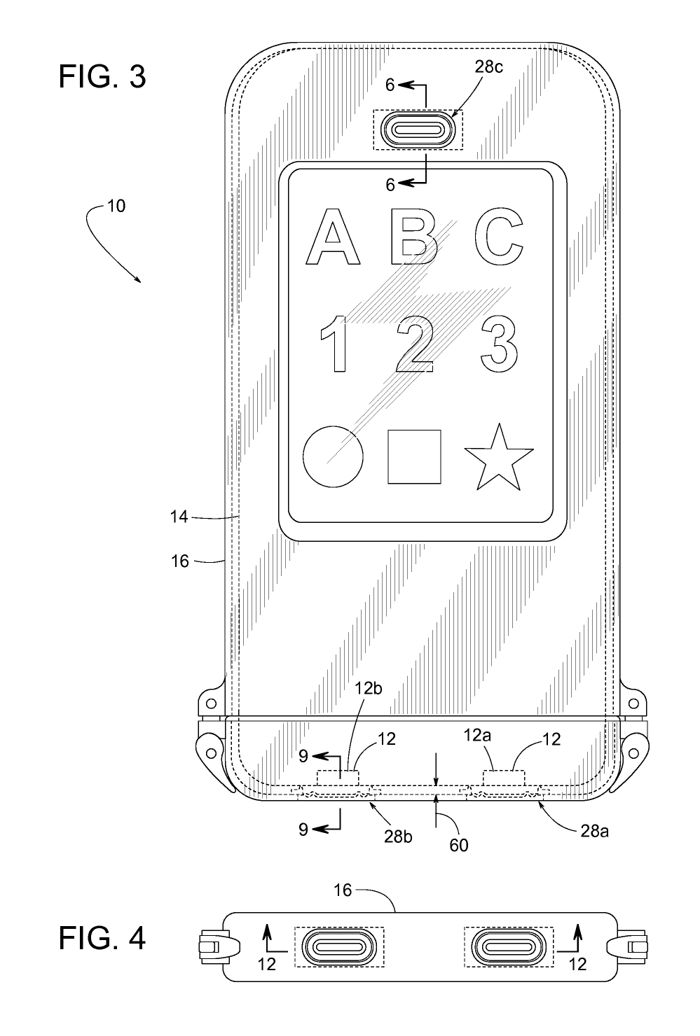

Diaphragm 30 being relatively soft enables seal 44 to effectively seal against outer surface 46 of digital device 14. When digital device 14 is installed within enclosure 16, as shown in FIGS. 3, 4, 6, 9 and 12, seal 44 sealingly engages the digital device's outer surface 46 and encircles one or more openings 56 leading to audio transducer 12. As a result, seal 44, web portion 42, central portion 38 and digital device 14 define a substantially sealed chamber 58 (e.g., chamber 58a, 58b and 58c) between diaphragm 30 and audio transducer 12. Chamber 58 being sealed helps ensure that sound waves efficiently transfer between audio transducer 12 and diaphragm 30, rather than the sound waves dispersing throughout a gap 60 between digital device 14 and enclosure wall 22. Chamber 58 being sealed and thus isolated from the rest of interior space 24 may also minimize crosstalk between two audio transducers 12 (e.g., between microphone 12b and speaker 12a), wherein such crosstalk might otherwise occur via gap 60 extending between the two transducers.

In some examples, diaphragm 30 and all its components (e.g., items 38, 42, 40 and 44) is plastic injection molded as a seamless unitary piece. In some examples, each diaphragm 30 is overmolded with enclosure 16 and/or its hatch 32. Overmolding not only allows diaphragm 30 (including its seal 44) to be of a different material softer than that of enclosure 16 and hatch 32, but overmolding also provides an effective means for joining diaphragm 30 to enclosure 16. In some examples, overmolding is accomplished by first plastic injecting one part 16 or 30 in a first mold, reinserting the injected part in a second mold, and then plastic injecting the other part 16 or 30 in the second mold to create a joined diaphragm/enclosure part. In other examples, overmolding is accomplished by plastic injection molding both parts 16 and 30 into a single multi-shot mold designed to produce a joined diaphragm/enclosure in a single molding cycle

In some examples, the joint is the result of diaphragm 30 and enclosure 16 melting or welding to each other at an interface 64. In some examples, the welded joint is strengthened by a mechanical interlock between the diaphragm's mounting flange 40 and enclosure wall 22. Examples of such a mechanical interlock at interface include, but are not limited to, a tongue-and-groove connection, dovetail connection, etc.

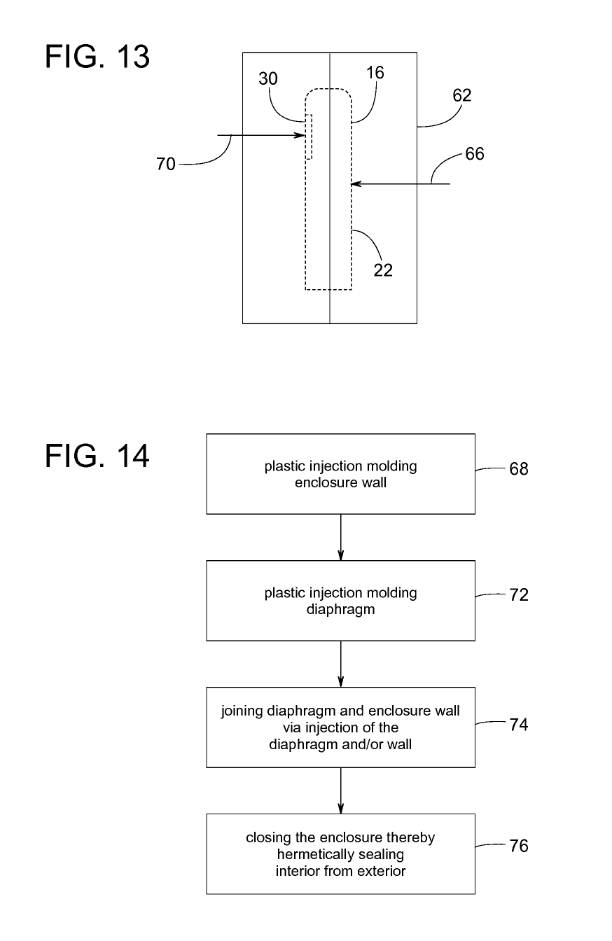

For illustration, arrow 66 of FIG. 13 and block 68 of FIG. 14 represent plastic injection molding enclosure wall 22. Arrow 70 of FIG. 13 and block 72 of FIG. 14 represents plastic injection molding diaphragm 30. In some examples, at least one plastic injection mold 62 is used for overmolding diaphragm 30 to enclosure wall 22, and in other examples, enclosure wall 22 is overmolded to diaphragm 30. Block 74 of FIG. 14 represents joining diaphragm 30 to enclosure wall 22 at acoustic window area 28 by either plastic injection molding enclosure wall 22 to diaphragm 30 or plastic injection molding diaphragm 30 to enclosure wall 22. Block 76 illustrates hermetically sealing interior 24 from exterior 26 by closing enclosure 16.

In some examples, a similar overmolding process is used for creating a relatively soft seal 36 melted or welded to the harder material of hatch 32. Seal 36 provides a compliant hermetic seal between hatch 32 and the rest of enclosure 16. In some examples, seal 36 and one or more diaphragms 30 of the same relatively soft material are simultaneously overmolded to the harder material of hatch 32. Likewise and alternatively, seal 36 is overmolded to enclosure wall 22 to create an equivalent hermetic seal between hatch 32 and enclosure wall 22.

Enclosure wall 22, hatch 32 and diaphragm 30 can be of any desired material. Material examples of enclosure wall 22 and wall portions of hatch 32 include, but are not limited to, polycarbonate, nylon, acrylonirile butadiene styrene (ABS), polyurethane and thermoplastic elastomer (TPE). Material examples of diaphragm 30 and/or seal 36 include, but are not limited to, polyurethane and thermoplastic polyurethane (TPU), wherein TPU is sometimes considered a subset of TPE.

Although the invention is described with respect to a preferred embodiment, modifications thereto will be apparent to those of ordinary skill in the art. Enclosure 16, for example, may include one or more additional features including, but not limited to, an audio jack, a main viewing window, one or more pushbutton elements, etc. In some examples, such additional features are watertight to maintain the hermetic integrity of enclosure system 10. The term, “watertight” means the relevant structure is substantially impervious to liquid water at a pressure differential of about 0.06 kg/cm². The scope of the invention, therefore, is to be determined by reference to the following claims:

1. An enclosure system for housing a digital device that includes an audio transducer, wherein the audio transducer is at least one of a speaker and a microphone, the enclosure system comprising:
an enclosure having an enclosure wall defining an acoustic window area, an interior space and an exterior, the interior space being sized to receive the digital device therein, the enclosure being configurable selectively between an open configuration and a closed configuration, the interior space being substantially hermetically sealed from the exterior when the enclosure is in the closed configuration; and
a diaphragm disposed on the enclosure at the acoustic window area, the diaphragm comprising a central portion and a web portion encircling the central portion, the central portion and the web portion each having a material thickness, the material thickness of the central portion being greater than that of the web portion.

2. The enclosure system of claim 1, wherein the central portion is wavy.

3. The enclosure system of claim 1, wherein the web portion is more planer than the central portion.

4. The enclosure system of claim 1, wherein the central portion and the web portion are softer than the enclosure wall.

5. The enclosure system of claim 1, wherein the diaphragm is a seamless unitary piece.

6. The enclosure system of claim 1, wherein the diaphragm further comprises a mounting flange and a seal, the mounting flange being joined to the enclosure wall, the web extending between the central portion and the mounting flange, the seal extending from the mounting flange to the central portion, the seal engaging the digital device when the digital device is disposed within the interior space of the enclosure while the enclosure is in its closed configuration.

7. The enclosure system of claim 6, wherein the diaphragm is a seamless unitary piece.

8. An enclosure system comprising:
an enclosure having an enclosure wall defining an acoustic window area, an interior space and an exterior, the enclosure being configurable selectively between an open configuration and a closed configuration, the interior space being substantially hermetically sealed from the exterior when the enclosure is in the closed configuration;
a digital device that includes a first audio transducer, the first audio transducer being one of a speaker and a microphone, the digital device being disposed within the interior space of the enclosure with the first audio transducer being in proximity with the acoustic window area; and
a diaphragm disposed on the enclosure at the acoustic window area, the diaphragm comprising a central portion, a web portion, a mounting flange and a seal, the mounting flange being joined to the enclosure wall, the web portion extending between the flange and the central portion, and the seal extending from the mounting flange and engaging the digital device.

9. The enclosure system of claim 8, wherein the central portion and the web portion each having a material thickness, and the material thickness of the central portion being greater than that of the web portion.

10. The enclosure system of claim 8, wherein the seal, the web portion, central portion and the digital device define a substantially sealed chamber between the diaphragm and the first audio transducer, the digital device includes a second audio transducer being one of the speaker and the microphone, the second audio transducer being outside the substantially sealed chamber.

11. The enclosure system of claim 8, wherein the central portion is wavy.

12. The enclosure system of claim 8, wherein the web portion is more planer than the central portion.

13. The enclosure system of claim 8, wherein the central portion and the web portion are softer than the enclosure wall.

14. The enclosure system of claim 8, wherein the diaphragm is a seamless unitary piece.

15. An enclosure method pertaining to an enclosure for a digital device that includes an audio transducer, the enclosure defining an interior space and an exterior, the enclosure method comprising:
plastic injection molding an enclosure wall of the enclosure, the enclosure wall defining an acoustic window area;
plastic injection molding a diaphragm of the enclosure;
joining the diaphragm to the enclosure wall at the acoustic window area by performing at least one of:
a) plastic injection molding the enclosure wall, and
b) plastic injection molding the diaphragm; and
hermetically sealing the interior space of the enclosure from the exterior.

16. The enclosure method of claim 15, further comprising:
inserting the digital device within the interior space of the enclosure; and
positioning the audio transducer of the digital device in proximity with the diaphragm.

17. The enclosure method of claim 15, wherein the diaphragm is softer than the enclosure wall.

18. The enclosure method of claim 15, wherein the diaphragm is wavy.

19. The enclosure method of claim 15, wherein the diaphragm comprises a central portion and a web portion encircling the central portion, wherein the central portion and the web portion each have a material thickness, and the material thickness of the central portion is greater than that of the web portion.
